(19) United States
(12) Patent Application Publication
(10) Pub. No.: US 2002/0168773 A1
(43) Pub. Date: Nov. 14, 2002

(54) Method and apparatus for evaluating performance of anion exchange resins, and condensate demineralizers

(76) Inventors: Tomoaki Ito, Tokyo (JP); Masashi Fujita, Tokyo (JP)

Correspondence Address: ROSENTHAL & OSHA L.L.P., 1221 MCKINNEY AVENUE, SUITE 2800, HOUSTON, TX, 77010, US

(21) Appl. No.: 09/924,021

(22) Filed: Aug. 7, 2001

(30) Foreign Application Priority Data
Aug. 7, 2000 (JP) 2000-239207

(51) Int. Cl. G01N 30/02

(52) U.S. Cl. 436/37; 436/161; 436/133; 422/70

(57) ABSTRACT

The performance of an anion exchange resin is evaluated on-line by measuring inorganic carbonic acid concentrations at the inlet and at the outlet of an ion exchange resin vessel (such as a demineralizer vessel) of an ion exchange apparatus such as a condensate water demineralization system. Moreover, an MTC (Mass Transfer Coefficient) with respect to the inorganic carbonic acid is calculated and the dynamic performance and/or degree of degradation of the anion exchange resin are evaluated. The degree of degradation of the anion exchange resin is evaluated from the MTC and the replacement timing, lifetime, and throughput capacity for the anion exchange resin are judged.

### BACKGROUND OF THE INVENTIONS

1. Field of the Invention

The present invention relates to a method and an apparatus for evaluating the performance of anion exchange resins and condensate demineralizers, and in particular to a method and an apparatus for evaluating the performance of anion exchange resins used in ion exchange resin vessels of condensate demineralizers used in fossil-fueled power plants or nuclear power plants or anion exchange resin columns of ion exchange deionizers used for other industrial applications such as the production of ultra pure water, and to condensate demineralizers which include performance evaluation apparatus. In the present application, condensate demineralizers used on recycle condensate water lines equipped in fossil-fueled on nuclear power plants are given as the example of ion exchange deionizers (demineralizers) and the present invention is described for anion exchange resins used in condensate demineralizer vessels.

2. Description of the Related Art

In the power generation system at a fossil-fueled on nuclear power plant, the vapor after driving the generator turbine is cooled by sea water or the like to produce condensate. The condensate is heated again to produce vapor for driving the generator turbine to generate power, and the cycle is repeated. The water to be recycled in this cycle is contaminated with various impurity ions, fine particles of iron oxides (crud) or the like. Because of this, the condensate must be highly purified in order to prevent corrosion of the boiler, vapor generator or nuclear reactor, or scale deposition. Thus, various condensate purification apparatuses such, for example, as a mixed bed type condensate demineralizers, powder ion exchange resin filters, and a hollow fiber filters are used by themselves or in combination thereof in the recycle condensate water line. Moreover, when sea water is employed as the cooling water for the recycle line, in general, the possibility of leakage of the sea water into the condensate cannot be ignored, and therefore, the condensate demineralizer functions as an important fail-safe means in the unlikely event of the sea water leakage.

A typical mixed bed type condensate demineralizer system comprises a water service assembly including a plurality of condensate demineralizer vessels, (hereinafter referred to as “demineralizer vessels”) and a regeneration assembly for regenerating the ion exchange resins used in the demineralizer vessels. A demineralizer vessel is usually filled with a mixture of a strong acidic cation exchange resin having the H-form or NH₄-form and a strong basic anion exchange resin having the OH-form.

In such a condensate demineralizer system, the treatment of condensate is carried out as follows. A plurality of demineralizer vessels are placed in parallel in the condensate demineralizer system and the condensate is passed through the demineralizer columns in parallel to remove the impurity ions such as Na ion and Cl ion in the condensate by ion exchange and the metal oxide impurities such as crud by filtering effect or physical adsorbing effect, to obtain purified treated water. A plurality of demineralizer vessels are provided in such a condensate demineralization system in order to allow continuous operation of the system even when the capacity of ion exchange resins is reduced over time. In other words, when the treatment of condensate is continuously carried out in the condensate demineralization system, any one of the demineralizer vessel may sustain pressure loss due to accumulation of crud or may reach a throughput end point, or the ion exchange resins of the demineralizer vessel may be saturated with impurity ions. As a consequence, the demineralizer vessel will eventually reach the terminating point for passing water. In this case, the demineralizer vessel which has reached the terminating point is separated from the condensate demineralization system, but because a plurality of demineralizer vessels are provided in the condensate demineralization system, condensate water can be continuously treated using other demineralizer columns.

The ion exchange resins in the demineralizer vessel are then introduced to the regeneration step. In the regeneration step, the ion exchange resins in the demineralizer vessel is transferred to a regenerating vessels within a regeneration facility and go through the regeneration process. After completion of the regeneration process, the regenerated ion exchange resins are returned to the demineralizer vessel. The regeneration process includes a backwash step where the metal oxide impurities such as crud attached onto the surface of the ion exchange resins are water washed and removed by air scrubbing, a separation step for separating into the cation exchange resin and anion exchange resin, and a desorbing step for desorbing impurity ions from both cation and anion exchange resins by passing acid regenerating agent, such as hydrochloric acid or sulfuric acid, through the cation exchange resin and alkali regenerating agent, such as sodium hydroxide, through the anion exchange resin. As a regeneration method, there are a single vessel regeneration method in which the anion exchange resin is separated to the upper layer and the cation exchange resin is separated to the lower layer by the relative density difference and a distinctive vessel regeneration method in which the two ion exchange resins are separated by the relative density difference and each resin is regenerated at each distinct regeneration column. After the completion of regeneration, the ion exchange resins are usually transferred to a tank and allowed to wait until the ion exchange resins in another demineralizer vessel reaches the terminating point. The ion exchange resins in the demineralizer vessel which reached the terminating point is removed and the waiting ion exchange resins are transported to the demineralizer vessel as a mixed bed of the cation exchange resin and anion exchange resin. Here, the mixing of the cation and anion exchange resins to produce a mixed bed is generally performed with a preliminary pre-mixing and post-mixing in the demineralizer vessel. It is also possible to employ a method where no standby tank is provided, and the ion exchange resins from a demineralizer vessel are regenerated and just returned to the original desalination column.

In recent years, the desired demineralization performance of the condensate demineralizer, that is, the desired quality of the water treated by the demineralizer, is becoming higher and higher from the viewpoint of prevention of the corrosion of the boiler, vapor generator, and nuclear reactor, and of the scale deposition. For example, the target concentration for each of Na ion, Cl ion, and SO₄ ion is less than 0.1 μg/L (liter) and more preferably, less than 0.01 μg/L. The impurities as described above are usually captured by the ion exchange resins within the condensate demineralizer vessel, but when the performance of the ion exchange resins is degraded, the impurities cannot be sufficiently captured, and a portion of the impurities leaks out into the treated water. The impurities then flows into the boiler, vapor generator, and/or nuclear reactor, causing problems such as corrosion and scale deposition. The ion exchange resins used in the condensate demineralizer column are eventually degraded after repeated use by regeneration as described above, and deterioration of their performance is unavoidable. Therefore, it is important that the degradation progress condition of the ion exchange resins be known for judging the timing for replacing the ion exchange resins. An accurate judgment will allow for effective use of the used resource. In particular, in a nuclear power plant, the accurate judgment is advantageous as it will allow for reduction in the amount of waste produced, and consequently, the running cost of the condensate demineralization system can be reduced. The performance deterioration is more dominant in the anion exchange resin, and the performance deterioration is mainly due to the contamination of the anion exchange resin with organic matter or the like.

According to recent studies, it has been shown that the reaction rate of the anion exchange resin drops due to the influence from the cation exchange resin used in the condensate demineralization system of a power plant. More specifically, the cation exchange resin which has Fe ion and Cu ion adsorbed will experience, though in a small amount, an oxidation decomposition reaction due to the catalyst action of these heavy metal ions and contact with the oxygen dissolved in the water and oxygen in air. Because of this reaction, a decomposition product of the oligomer of styrene sulfonate or a low molecular polymer which is a portion of the base structure of the cation exchange resin is produced. These eluted decomposition products are then adsorbed onto and contaminate the surface of the anion exchange resin, causing the reactivity of the anion exchange resin to decrease. When the reactivity of the anion exchange resin is decreased, the substances eluted from the cation exchange resin are not captured by the anion exchange resin and remains in the water treated by the condensate demineralization system. These substances then flow into the boiler, vapor generator, and nuclear reactor and produce CO₂ and SO₄²⁻ by thermal decomposition under high temperature, and thus, the amount of ion is increased. The condensate demineralization system is no longer capable of handling the sea water leakage. As a consequence, the quality of the water treated by the condensate demineralization system is degraded. In a typical ion exchange resin regeneration method, these decomposition products are not easily detachable from the anion exchange resin, and therefore, it is believed that this is one reason for the significant performance degradation of the anion exchange resin. From these facts, the performance evaluation of the anion exchange resin is considered important, in particular for safety management in a power plant, and currently, a reaction rate test is employed as a performance evaluation.

In addition to the oxidation and degradation decomposition products from the cation exchange resin, an anticorrosive agent that is used in the periodical examination of a power plant and secondary materials affect the reaction rate of the anion exchange resin. When starting the condensate demineralization system after the periodical examination, water is passed through the demineralization system to purify the water in the recycle route. During this process, impurities such as a secondary material contaminates the anion exchange resin as an impurity of the recycle assembly, thereby reducing the reaction rate. In fact, there are many reports of such a phenomenon where the reaction rate of the anion exchange resin is temporarily reduced immediately after restarting the demineralization system after periodical examination.

As a test for the reaction rate, for an anion exchange resin in a demineralizer vessel of a condensate water demineralization system in a PWR type nuclear power plant and in a fossil-fueled power plant, the performance of the anion exchange resin is evaluated by determining the reaction rate (reactivity) by an MTC method (mass transfer coefficient calculating method) and from the removal performance for sulfate ion, in which a solution having a predetermined concentration of the ammonium ion (ammonia water) and of the sodium sulfate is passed through a mixed bed test column having the anion exchange resin sampled from the demineralizer vessel and regenerated and a new cation exchange resin. In a BWR type nuclear power plant, an SB method (shallow bed demineralization percentage measuring method) is adopted for evaluating the anion exchange resin of the demineralizer vessel of the condensate demineralization system using a single bed of the sampled anion exchange resin.

The MTC method and SB method are both off-line type method and requires complicated manipulations such as sampling the ion exchange resin when it is being transferred for regeneration and pretreating (regeneration, etc.) the resin sample in a laboratory or the like. Thus, a large amount of work and time is required before the reactivity can actually be determined. The methods also have a disadvantage that the resulting measurement value will be different depending on the skill of the analyzing person. Moreover, the performance evaluation target is the anion exchange resin sample taken when the ion exchange resin is being transferred for regeneration. This allows for evaluation of the performance of the regenerated anion exchange resin at the beginning of the exhaustion cycle of working demineralizer vessel, but does not allow for sufficient evaluation of the performance of the anion exchange resin when there is a change in the quality of the water treated during the exhaustion cycle or when there is a continuous impurity accumulation load on the regenerated anion exchange resin. Furthermore, the test results do not necessarily accurately indicate the performance of the anion exchange resin which is being in use.

This also applies to the ion exchange resins used in standard deionization ion exchange resin vessels apparatus, other than those used in the power plants. Typically, a mixed bed or a multiple bed of a cation exchange resin and an anion exchange resin is used, and regeneration is performed after a predetermined amount of deionized water is collected. Depending on the usage of the treated water (deionized water), a highly purified treated water may be desired. In such a case, the ion exchange resins may not be regenerated, and may be replaced by new ion exchange resins after a predetermined amount of deionized water is collected. It is important to keep good performance of the ion exchange resins and suitable replacement thereof in view of managing the water quality, but the performance evaluation and timing for replacement for the ion exchange resins is currently managed by the resistivity value of the water at the exit of the ion exchange resin vessel, but this evaluation method does not necessarily accurately evaluate the performance of the anion exchange resin. In a standard ion exchange water deionizer, the anion exchange resin influences the cation exchange resin, as opposed to the case of the condensate demineralization system in a power plant, and a phenomenon has been observed in which the reaction rate of the cation exchange resin is decreased.

### SUMMARY OF THE INVENTION

The present invention is conceived to solve the above mentioned problems, and one object of the present invention is to provide a method and apparatus for evaluating the performance of anion exchange resins, and condensate demineralization systems, which can solve the above problems.

In order to achieve at least the object mentioned above, according to the present invention, there is provided a method for evaluating the performance of anion exchange resins, comprising the steps of: measuring the inorganic carbonic acid concentration in the outlet water of an ion exchange resin vessel of an ion exchange deionization (demineralization) system to evaluate the performance (such, for example, as reactivity and degree of degradation) of the anion exchange resin being in use in the ion exchange resin vessel. According to another aspect of the present invention, there is provided an anion exchange resin performance evaluation apparatus comprising: a monitoring device for measuring inorganic carbonic acid concentrations in the feed water and outlet water of an ion exchange resin vessel of an ion exchange deionization system; a calculation device for calculating the inorganic carbonic acid removal performance and/or MTC of the anion exchange resin used in the ion exchange resin vessel from the inorganic carbonic acid concentrations of the feed water and of the outlet water measured by the monitoring device; and a judgment device for evaluating the degree of degradation from the calculated inorganic carbonic acid removal performance and/or MTC of the anion exchange resin and judging the replacement timing, the lifetime, and the throughput capacity for the anion exchange resin. According to another aspect of the present invention, the performance evaluation apparatus for anion exchange resins is provided in condensate water demineralizer vessels. The term “inorganic carbonic acid” is defined to include carbonate ion (CO₃²⁻), bicarbonate ion (HCO₃⁻), and free carbonic acid (H₂CO₃). Therefore, the “inorganic carbonic acid concentration” substantially represents the concentration of “carbonate ion, bicarbonate ion+free carbonic acid”. According to the method for evaluating the performance of anion exchange resins of the present invention, it is possible to continuously or intermittently monitor, on-line, the inorganic carbonic acid concentration of at least the outlet water. Thus, it is possible, to some extent, to predict or judge the endpoint of passing water through ion exchange resins from the variation in the inorganic carbonic acid concentration as a function of time. Moreover, even in a case where regeneration of ion exchange resins is not performed (non-generable) and the ion exchange resins are replaced by new ion exchange resins due to the demand for very high purity treated water, the prediction and judgment of the endpoint for passing water through the ion exchange resins are possible by the method of the present invention.

### BRIEF DESCRIPTION OF THE DRAWINGS

FIG. 1 is a graph showing a relationship between the usage period and the dynamic performance (MTC value with respect to the sulfuric acid ion according to the prior art method) of a regenerated anion exchange resin used in a demineralizer vessel of a certain condensate water demineralization system.

FIG. 2 is a graph showing a relationship between the usage period and the dynamic performance (a value of the MTC with respect to the inorganic carbonic acid represented as a percentage with respect to a new resin, where the value for a new anion exchange resin is represented by 1 according to the present invention) of the regenerated anion exchange resin used in the demineralizer vessel of the condensate water demineralization system of FIG. 1.

FIG. 3 is a schematic partial explanation view showing a structure of a condensate water demineralization system according to the present invention.

### DESCRIPTION OF PREFERRED EMBODIMENT

It is estimated that the condensate water at the inlet side of a condensate demineralizer vessel in a PWR type nuclear power plant always contains 5 to 10 μg/L of the inorganic carbonic acid, the condensate water at the inlet side of a condensate demineralizer vessel in a BWR type nuclear power plant always contains 3 to 5 μg/L of the inorganic carbonic acid, and the condensate water at the inlet side of a condensate demineralizer vessel in a fossil-fueled power plant always contains several hundreds to several thousands μg/L of the inorganic carbonic acid. The inorganic carbonic acid such as carbonate ion and bicarbonate ion is removed by ion exchange or adsorption on the anion exchange resin in the demineralizer vessel of the condensate water demineralization system, and the inorganic carbonic acid is loaded on the anion exchange resin. As described, because the concentration of the inorganic carbonic acid in the condensate water is relatively high compared to the other anions such as chloride ion and sulfate ion, when the concentration of the inorganic carbonic acid in the inlet water of the desalination column is relatively stable, the performance of the anion exchange resin for removing the inorganic carbonic acid can be evaluated by directly measuring the concentration of the inorganic carbonic acid in at least the outlet water of the demineralizer vessel. The present inventors have noticed this fact and another fact that the performance of the anion exchange resin such, for example, as reactivity and degree of degradation can be evaluated from the removal performance for the inorganic carbonic acid. In addition to the measurement of the concentration of the inorganic carbonic acid in the outlet water of the desalination column, it allows for a more accurate performance evaluation if the concentration of the inorganic carbonic acid in the inlet water to the demineralizer vessel can be measured for performance evaluation of the anion exchange resin. In this case, sufficient performance evaluation of the anion exchange resin can be performed even when the concentration of the inorganic carbonic acid in the inlet water of the desalination column changes. The measurement of the inorganic carbonic acid concentration can either be performed continuously or intermittently. In some cases, the measurement can be performed at a point of time when the degradation in the reactivity of the anion exchange resin is expected to reach an allowable limit. In order to measure the inorganic carbonic acid concentration, it is only required to provide an inorganic carbonic acid concentration meter at the outlet section, and when necessary, at the inlet section, of the ion exchange resin vessel, such as a demineralizer vessel. This also applies to the ion exchange resin vessel in a typical water deionization system. For example, in a case of a plural bed type water deionization system, this applies to the anion exchange resin vessel. In this manner, according to the present invention, it is possible to continuously or intermittently measure, on-line, the inorganic carbonic acid concentration during the water collection at the condensate water demineralization system, and thus, the performance of the anion exchange resin (such as reactivity and degree of degradation) within demineralizer vessel can be evaluated. More preferably, the mass transfer coefficient (MTC) with respect to the inorganic carbonic acid can be continuously or intermittently calculated on the basis of the measurement value of the inorganic carbonic acid concentrations in the inlet water and in the outlet water of the demineralizer vessel. It is possible then to manage or evaluate the dynamic performance and the degree of degradation as time passes, of the anion exchange resin currently being in use for a case where the ion exchange resin is not regenerated (non-regenerable) and of the regenerated anion exchange resin for a case where the ion exchange resins are regenerated and repeatedly used. Thus, the replacement timing and lifetime of the anion exchange resin can be judged, and moreover, the throughput capacity can also be judged. This is based on a new finding, as will be described, that the MTC with respect to the inorganic carbonic acid calculated on-line according to the present invention and the MTC with respect to the chloride ion and sulfate acid ion as calculated from the conventional off-line method have a close correlation. In contrast to the MTC measuring method of the present invention, the conventional MTC value measurement requires a special test solution (for example, a solution of ammonia and sodium sulfate). However, this solution cannot be passed through the operating ion exchange resin vessel, and thus, the conventional method suffers a disadvantage that the ion exchange resin must be sampled and the MTC must be measured spending time as long as a few days.

MTC is a numerical value which indicates the ion exchange reaction rate (reactivity) of the ion exchange resin and directly represents the ion exchange ability (performance) of the resin. In order to calculate the MTC value from the measurement values of the inorganic carbonic acid concentrations at the inlet and the out of the ion exchange resin vessel, the following equation (1) is used. In an off-line type conventional method, the MTC with respect to the sulfate ion and chloride ion can be calculated from equation (1) by replacing the C and C₀ in the equation by “sulfate ion concentration” and “chloride ion concentration” respectively at the inlet and outlet of the test column.

$$\begin{matrix}( Equation 1 ) & ( 1 ) \\ K = \frac{V}{6 ( 1 - ϵ ) \cdot Z \cdot A \cdot R} \cdot dm \cdot ( ln {C}_{0} / C ) & \end{matrix}$$

In equation 1, K represents the mass transfer coefficient MTC (m/sec); C represents the inorganic carbonic acid concentration of the inlet water; C₀ represents the inorganic carbonic acid concentration of the outlet water; ε represents the void ratio of the ion exchange resin layer; Z represents the height of the ion exchange resin layer (m); A represents the cross sectional area of the ion exchange resin layer (m²); R represents the anion ion exchange resin percentage (volume percent) in the ion exchange resin layer; V represents the flow rate of the passing water (m³/sec); and dm represents the particle radius of the ion exchange resin (m).

The concentrations of the chloride ion and sulfate ion in the condensate water at the inlet side of the demineralizer vessel of an operating condensate water demineralization system are, for example, less than about 0.2 μg/L and less than about 0.1 μg/L, respectively, which are very small compared to the inorganic carbonic acid concentration to be measured in the present invention. In order to measure the chloride ion and sulfate ion concentrations, which are extremely small, an on-line measurement by an expensive ion chromatographic analyzer is required (refer to Japanese Patent Laid-Open Publication No. Hei 4-220562). Moreover, because the concentrations of the chloride ion and the sulfate ion in the condensate water are extremely small, even when the performance of the anion exchange resin filling the demineralization vessel is not degraded at all, the difference between the concentrations of these impurity ions at the inlet and at the outlet is small, and thus, even when these concentrations are measured on-line, similar to the present invention, with the expensive ion chromatographic analyzer, it is difficult to evaluate the reactivity and the degree of degradation of the anion exchange resin being in use from the measured information. The ion chromatographic analyzer is not capable of measuring the inorganic carbonic acid concentration. If the concentration of the chloride ion and of the sulfate ion is to be detected from the conductivity using a relatively inexpensive conductivity meter in place of the ion concentration measurement using an ion chromatographic analyzer, because the concentration of the chloride ion and sulfate ion for which the conductivity can be detected is at least 2˜3 μg/L, in order to evaluate the removal performance of the demineralization vessel for the chloride ion and sulfate ion (including MTC), it is necessary to inject chloride ion and sulfate ion with a concentration of at least several hundred μg/L into the condensate water which is the performance evaluation water, to prepare the inlet water of the demineralizer vessel. When this is performed, the quality of the condensate water to the demineralizer vessel will be degraded. In order to avoid such a case, it is necessary to employ an off-line method where the anion exchange resin is sampled from the operating demineralizer vessel during, for example, regeneration, and, in a laboratory or the like, pass the performance evaluation water having high concentrations of chloride ion and sulfate ion. In contract, the inorganic carbonic acid concentration in the condensate water at the inlet side of the demineralizer vessel, as described above, is significantly higher than the chloride ion concentration or the sulfate ion concentration. Thus, as the performance of the anion exchange resin is degraded, the inorganic carbonic acid concentration in the outlet water becomes higher, and therefore, the inorganic carbonic acid concentration is well suited as an indicator for the performance evaluation of the anion exchange resin. An advantage of the present invention should be clear from the above.

As described, in the present invention, the water to be treated by the ion exchange apparatus such as condensate water is passed as the performance evaluation water through the ion exchange resin vessel such as a demineralizer vessel, and the performance of the anion exchange resin can be evaluated. It is also true that the MTC value can be more accurately obtained when the inorganic carbonic acid concentration in the inlet water of the ion exchange resin vessel such as a demineralizer vessel is higher. Therefore, depending on the type of the performance evaluation water, it is possible to inject carbonic dioxide gas or soda water from outside to the inlet water in order to increase the inorganic carbonic acid concentration in the inlet water, at least during the measurement (or continuously). The amount of inorganic carbonic acid in the outlet water will be increased due to the injection of the carbon dioxide gas or soda water, but unlike the chloride and sulfate ions, the risk of the inorganic carbonic acid adversely affecting the pipes and device assembly is small even when the amount of leakage from the ion exchange resin vessel such as a demineralizer vessel is increased. Moreover, in a fossil-fueled power plant or in a PWR type nuclear power plant, in general, a degassing device is provided after the condensate water demineralization system and before the boiler or a vapor generator, and thus, the carbonic acid in the exiting water from the condensate water demineralization system is removed by the degassing device before entering the boiler or the vapor generator. Therefore, an increase in the inorganic carbonic acid concentration causes no problem.

According to the present invention, the object can be achieved to a sufficient degree by measuring at least the inorganic carbonic acid concentration in the outlet water of the ion exchange resin vessel actually being in use for water processing such as a demineralizer vessel. It is also possible to provide, in a sampling rack or the like, for example, a mini-column in which the inlet water to the ion exchange resin vessel can be sampled and having a layer height less than the height of the ion exchange resin layer (typically approximately between 0.6 and 1.2 m) of the ion exchange resin vessel actually being in use (hereinafter referred to as an “operating ion exchange resin vessel”), and more preferably, the layer height is less than ½ of the height of the ion exchange resin layer of the operating ion exchange resin vessel, and even more preferably, the layer height is between 1/10 and ⅓ of the height of the ion exchange resin layer of the operating ion exchange resin vessel. The mini-column is filled with the same ion exchange resin as the resin employed in the operating ion exchange resin vessel. A portion of the water entering the ion exchange resin vessel is passed through from the inlet of the mini-column and the mini-column is used in place of or in addition to the operating ion exchange resin vessel for evaluating the performance of the anion exchange resin. In this manner, because the layer height of the ion exchange resin of the mini-column is lower than the height of the ion exchange resin layer in the operating ion exchange resin vessel, the amount of leaking inorganic carbonic acid ions such as carbonate ions and bicarbonate ions will be greater than in the case of the operating ion exchange resin vessel, and thus, the precision of the performance evaluation and MTC value calculation for the anion exchange resin can be enhanced. When the mini-column is used in addition to the operating ion exchange resin vessel, it is possible usually to use only one of the two columns for normal performance evaluation and MTC value calculation of the anion exchange resin and to use the other too when necessary.

The anion exchange resin whose performance is to be evaluated by the present invention is not limited to an anion exchange resin in a mixed bed type ion exchange resin column such as a condensate water demineralizer vessel, and includes, for example, an anion exchange resin in an anion exchange resin vessel of a plural bed type ion exchange processing device such as a typical water deionization system. In order to judge the replacement timing and the lifetime of the anion exchange resin, and the throughput capacity, the present invention is usually applied to the regenerated anion exchange resin when the anion exchange resin is used with a repeated regeneration, such as in a case of the anion exchange resin used in a demineralizer vessel of a typical condensate water demineralization system, but the present invention is not limited to such a case, and the judgment can be made based on the data during the cycle from one regeneration till the next regeneration. On the other hand, when the present invention is to be applied to cases such as in an anion exchange resin used in an ion exchange resin vessel of a special condensate water demineralization system or deionized water production apparatus, in which the ion exchange resins are replaced without regeneration by fresh ion exchange resins with a pre-adjusted ionic form due to the demand for very highly purified treated water, the performance evaluation of the anion exchange resin being in use can be performed as time passes according to the present invention, and the replacement timing and lifetime of the anion exchange resin, and the throughput capacity of the ion exchange unit can be judged accordingly.

As an inorganic carbonic acid concentration measuring device, it is possible to use any device that can measure the concentration of the inorganic carbonic acid, but it is preferable to use an electric conductivity sensor with a gas permeation membrane. The structure and the measurement principle of such an electric conductivity sensor with a gas permeation membrane will now be described.

An electric conductivity sensor with a gas permeation membrane includes a deionized water line separate from a sample water line, and has a membrane module having a structure where the sample water and the deionized water contact each other with a gas permeation membrane in between. The gas permeation membrane used here allows the carbon dioxide and other gases permeate through, but does not allow the ionic constituents and organic materials. At the outlet of the deionized water, a cell and an electromagnetic valve are provided for measuring the electric conductivity and the temperature. Every time a measurement is started, fresh deionized water is supplied to the membrane module, the electromagnetic valve at the outlet is closed, and the deionized water is confined in the surface of the gas permeation membrane. On the other hand, sample water, pH of which is adjusted to less than 4 by adding phosphoric acid, continuously flows at the surface of the sample side of the membrane module, that is, the surface at the side opposite to the deionized water with respect to the gas permeation membrane. Because the sample water is adjusted to have an acidic pH, the bicarbonate ion and carbonate ion in the water has a form of a free carbonic acid (H₂CO₃). Because deionized water which does not include any carbonic acid is confined to the opposite side with respect to the gas permeation membrane, the carbonic acid in the sample water permeates through the gas permeation membrane in a form of carbon dioxide gas and moves to the deionized water side, until about five minutes later the carbonic acid concentrations in the sample water and in the deionized water reach an equilibrium. After the equilibrium is reached, the electromagnetic valve is opened and the deionized water which absorbed carbonic acid is forced to the electric conductivity and temperature measuring cell. When there is no other ionic constituent present, the carbonic acid concentration (carbon dioxide concentration) and the electric conductivity of the water is a function represented by a dissociation equilibrium constant which is a function of the temperature. Therefore, by measuring the temperature and the electric conductivity, the carbon dioxide concentration can be calculated. It is clear from the above that because, in the conductivity sensor, the influence of any ionic constituents other than carbon dioxide is averted by the gas permeation membrane, the inorganic carbonic acid concentration can be measured accurately even for sample water having other ion constituents such as chloride and sulfuric acid ions.

With the usage of such an electric conductivity sensor with a gas permeation membrane, a direct measurement of the inorganic carbonic acid concentration in condensate water (water entering or water exiting from a demineralizer vessel of a condensate water demineralization system) of a PWR type nuclear power plant or BWR type nuclear power plant is possible without injecting any agent to the performance evaluation water, and thus, the performance of the anion exchange resin can be evaluated and the MTC value in the ion exchange resin vessel such as a demineralizer vessel can be calculated.

Embodiments of the present invention will now be described in more detail. It should be understood that the present invention is not limited to these particular embodiments.

Table 1 shows correlation between the actually measured MTC values with respect to the sulfate ion and to the inorganic carbonic acid. Table 1 is created from Table 3 of the first example which will be described later. The “resin used in operation 1” represents an anion exchange resin used for approximately six months in a working demineralizer vessel of a certain condensate water demineralization system. The “resin used in operation 2” represents an anion exchange resin used for approximately two years and five months in a working demineralizer vessel. The MTC value for sulfate ion was calculated using the measured sulfate ion concentration of the inlet water and the measured sulfate ion concentration in the outlet water based on the prior art method where a performance evaluation water having a sulfate ion concentration of approximately 300 μg/L was passed though a test column in a laboratory. The MTC value with respect to the “new resin” in Table 1 represents a result of a test for a new resin and the MTC values with respect to each of the resins used in operation represents a result of a test after sampling the ion exchange resin from the desalination column of the condensed water desalination apparatus and regeneration process. In contrast, the measured MTC value with respect to the inorganic carbonic acid in Table 1 represents the MTC value calculated by measuring the inorganic carbonic acid concentration using electric conductivity sensor with a gas permeation membrane on the water entering and water exiting from the desalination column of the same condensed water desalination apparatus. Therefore, the test condition such as, for example, the water passing flow rate LV and the ion exchange resin layer height differ for the case of the sulfuric acid ion and for the case of the inorganic carbonic acid. In order to accommodate the difference, a “percentage with respect to a new resin” is also shown in Table 1, which uses, as a reference, the MTC value for the case when a new anion exchange resin is used. From the comparison between data for the sulfate ion and the inorganic carbonic acid in the “percentage with respect to a new resin” in Table 1, it should be clear that there is a strong correspondence.

TABLE 1

| | sulfate ion | | inorganic carbonic acid | |
|---|---|---|---|---|
| | | ratio with | | ratio with |
| | | respect to | | respect to |
| | MTC | that of a | MTC | that of a |
| | (× 10⁻⁴ m/sec) | new resin | (× 10⁻⁴ m/sec) | new resin |
| new resin | 2.00 | 1 | 1.20 | 1 |
| resin used in | 1.80 | 0.90 | 1.11 | 0.92 |
| operation 1 | | | | |
| resin used in | 1.05 | 0.53 | 0.61 | 0.50 |
| operation 2 | | | | |

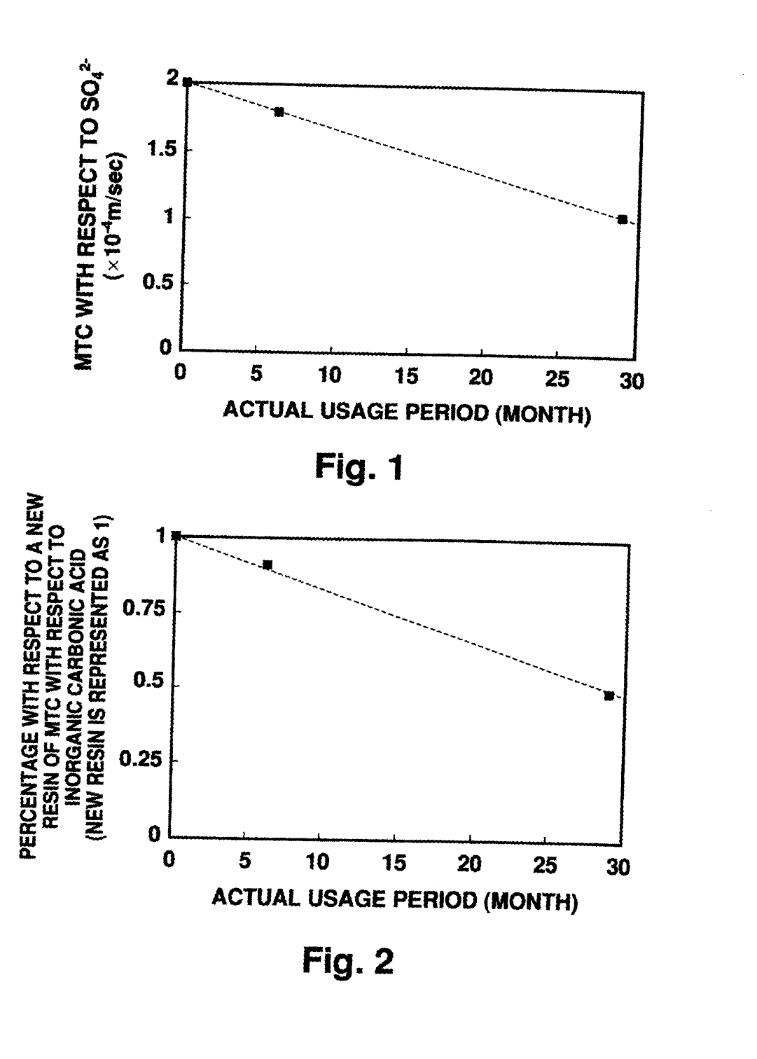

FIGS. 1 and 2 are graphs that shows the relationship between the used period of the regenerated anion exchange resin and the dynamic performance (MTC value), constructed on the basis of the data in Table 1. FIG. 1 is a graph showing the relationship between the MTC with respect to the sulfate ion and the operation usage period according to the prior art. FIG. 2 is a graph showing the relationship between the MTC with respect to the inorganic carbonic acid and the operation usage period using the demineralizer vessel according to the present invention. In FIG. 2, y axis shows a ratio of MTC with respect to the new resin such that the MTC of the new anion exchange resin is represented as 1. By comparing FIGS. 1 and 2, it should be clear that the two graphs are in good agreement with each other in their form although there is a difference in the units of the y axes.

As described, in general, a decrease in the MTC value of the anion exchange resin is due to fouling of the resin surface. Therefore, for example, the MTC value can be divided into four levels based on the fouling condition (degree of degradation) of the anion exchange resin and can be used as an indication for knowing the fouling condition of the anion exchange resin and the treated water quality of the operating ion exchange resin vessel. Normally, the MTC value of a new anion exchange resin with respect to the sulfate ion is about 2.0 (×10⁻⁴ m/sec). The standard for the replacement timing of the anion exchange resin of the demineralizer vessel is set at a time when the MTC of the regenerated anion exchange resin with respect to the sulfate ion has dropped to about 1.0 (×10⁻⁴ m/sec). The timing can therefore be judged by finding the corresponding MTC with respect to the inorganic carbonic acid in a ratio to that of the new resin. However, the timing for replacing the anion exchange resin, that is, the maxim allowable fouling, varies depending on the operation condition of the demineralizer (deionizer) and the desired quality of the treated water, and thus, should be individually judged for each application. Table 2 is an MTC value level table suggesting the corresponding performance of the regenerated anion exchange resin used in a demineralizer vessel having the above-mentioned relationship.

TABLE 2

| | | present | | |
|---|---|---|---|---|
| | | invention | | |
| prior art method | | inorganic | | |
| sulfate ion | | carbonic acid | | |
| | ratio of | ratio of | fouling | |
| | MTC value | MTC value | condition | |
| MTC value | with respect | with respect | of anion | actual |
| (× 10⁻⁴ m/ | to that of | to that of | exchange | quality of |
| sec) | a new resin | a new resin | resin | treated water |
| 1.5 | 0.75 | 0.75 | normal | normal quality |
| and more | and more | and more | | of water |
| 1.0˜1.5 | 0.5˜0.75 | 0.5˜0.75 | competing | high sulfate |
| | | | condition | ion |
| | | | between | concentration |
| | | | fouling and | |
| | | | desorption | |
| | | | during | |
| | | | regeneration | |
| 0.5˜1.0 | 0.25˜0.5 | 0.25˜0.5 | chronic | frequent |
| | | | fouling | occurrence of |
| | | | condition | water quality |
| | | | | degradation |
| 0.5 | 0.25 | 0.25 | complete | high ion |
| and less | and less | and less | fouling | leakage level |
| | | | condition | |

The MTC value level table (Table 2) can be used as a reference for judging the degree of degradation (fouling) of the anion exchange resin. According to this reference, the replacement schedule for the anion exchange resin can be prepared, the anion exchange resin can be ordered, and the replacement operation can be started, and thus, this reference is of great industrial use.

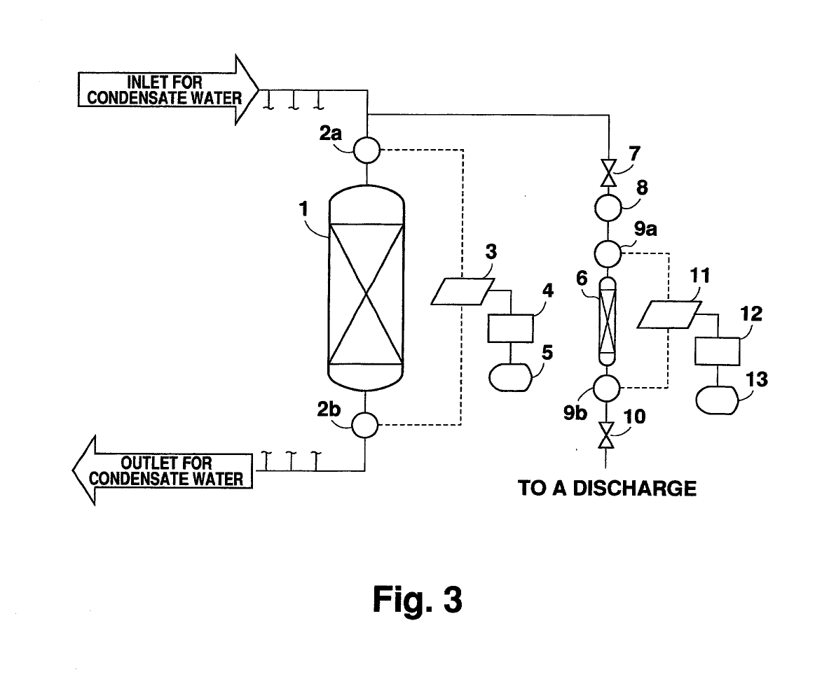

The present invention will now be described in more detail referring to FIG. 3 which is a schematic partial explanation view showing a structure of a condensate water demineralization system according to the present invention. In this system, four demineralizer vessels are provided in parallel, but only one of the demineralizer vessel 1 is shown in FIG. 3. Although only the water demineralization portion of the condensate water demineralization system is shown in FIG. 3, the condensate water demineralization system also includes a regeneration assembly and resin transfer pipes. Moreover, a valve is provided on each of the pipes at the upstream and downstream side of the demineralizer vessel 1, but these valves are not shown. Electric conductivity sensors 2a and 2b each with a gas permeation membrane are respectively provided in the pipe near the inlet and outlet of the demineralizer vessel 1. Measurement data related to the inorganic carbonic acid concentration in the inlet water and in the out water are recorded in, for example, a recording section 3 within a computer via a wiring shown by a dotted line from the electric conductivity sensors 2a and 2b each with a gas permeation membrane. The inorganic carbonic acid removal performance and/or the MTC of the anion exchange resin in the demineralizer vessel 1 are calculated at a calculation section 4 from these measurement data. As the “inorganic carbonic acid removal performance”, for example, the ratio between the inorganic carbonic acid concentration at the outlet (Cout) and the inorganic carbonic acid concentration at the inlet (Cin) (Cout/Cin, the leakage percentage of inorganic carbonic acid), or a value obtained by dividing the difference between the inorganic carbonic acid concentrations at the inlet and at the outlet by the inorganic carbonic acid concentration at the inlet [(Cin−Cout)/Cin, the inorganic carbonic acid removal ratio] can be used. The measured values of the inorganic carbonic acid concentrations at the inlet and the outlet and the inorganic carbonic acid removal performance and/or MTC value calculated from these measurement values are shown on a display section 5. In addition, when necessary, “anion exchange resin fouling condition” and “quality of treated water” in the MTC value level table shown in Table 2, “replacement timing for anion exchange resin”, “lifetime of anion exchange resin”, “throughput capacity”, and various pieces of management information such as countermeasures based on these pieces of information are also shown on the display section 5. The recording section 3, calculation section 4, and the display section 5 are usually conveniently built into a computer, but the present invention is not limited to such a configuration. A “monitoring mechanism for measuring the inorganic carbonic acid concentration in the inlet water and in the outlet water”, “calculation mechanism for calculating the inorganic carbonic acid removal performance and/or MTC of the anion exchange resin”, and “judgment mechanism for judging the replacement timing, lifetime, and throughput capacity of the anion exchange resin” according to the present invention cannot be clearly distinguished (identified) in FIG. 3, but one can roughly consider that the electric conductivity sensors 2a and 2b with a gas permeation membrane and the recording section 3 mainly form the “monitoring device”, the calculation section 4 mainly forms the “calculation device”, and the calculation section 4 and the display section 5 mainly forms the “judgment device”.

FIG. 3 also shows a mini-column 6 and its peripheral devices, but it should be clear from the above description that these peripheral components are not a necessity, and the object of the present invention can be achieved without these components. On the other hand, the object of the present invention can also be achieved by omitting the electric conductivity sensors 2a and 2b with a gas permeation membrane, recording section 3, calculation section 4, and display section 5, and use only the mini-column and its peripheral devices. The mini-column 6 can collect a portion of the water entering the demineralizer vessel 1 via the valve 7 and flow rate measuring device 8 through a pipe. Moreover, the mini-column is filled with the ion exchange resin identical to the working demineralization vessel with a resin layer height smaller than the ion exchange resin layer height of the working demineralization vessel, and preferably with a resin layer height smaller than ½ of the ion exchange resin layer height of the working demineralization vessel. The inorganic carbonic acid concentration of the water passing through and exiting from the mini-column 6 is generally higher than the inorganic carbonic acid concentration at the outlet of the working demineralization vessel. Thus, the inorganic carbonic acid removal performance and/or MTC of the anion exchange resin obtained using electric conductivity sensors 9a and 9b with a gas permeation membrane, a recording section 11, and a calculation section 12 will be more precise. A display section 13 can display various pieces of management information just like the display section 5 for the demineralizer vessel 1. The water exiting from the mini-column 6 is sent to a discharge via the electrical conductivity sensor 9b with a gas permeation membrane and a valve 10.

In the condensate water demineralization system according to the present invention, known means can also be used in combination. For example, an acid electrical conductivity meter can be provided at a pipe downstream of each demineralization vessel or where the treated water join together, in order to detect any accidental ion leakage during normal operation. It is also possible to provide a branched pipe at the condensate water inlet pipe, and provide an open/close valve and an electrical conductivity meter on the branched pipe, to measure the condensate water at the electrical conductivity meter by intermittently opening the open/close valve, in order to detect possible sea water leakage.

The judgment and prediction of the replacement timing of the anion exchange resin can be made by, for example, the following method. If the change in the MTC value with respect to the inorganic carbonic acid measured in every regeneration process, is plotted in relation between the MTC and time period (number of days), it is generally true that this relationship shows a linear function with a constant slope. Therefore, an MTC value for a minimum allowable ion exchange capacity can be set as a predetermined threshold value for the resin replacement timing. Alternatively, another threshold value near the above-mentioned threshold value can be set at which point the preparation for the resin replacement should be made. The judgment and prediction can be performed from the comparison with these threshold values. The throughput capacity to the next regeneration endpoint can be determined, in the case of an almost constant water quality at the inlet of the demineralizer vessel, based on, for example, accumulated data for the working demineralizer vessel, by judging the amount of treated water that can possibly be collected (throughput capacity) from the MTC value of the anion exchange resin with respect to the inorganic carbonic acid as determined immediately after the regeneration process. The throughput capacity during the lifetime of the anion exchange resin (to a replacement endpoint) is reached can also be determined by judging the expected lifetime from the MTC value. In the condensate water demineralization system according to the present invention, it is possible to continuously or intermittently monitor at least the inorganic carbonic acid concentration at the outlet of the demineralizer vessel and to predict or judge, to a certain degree, the endpoint of passing water, from the variation in the inorganic carbonic acid concentration as time passes.

### EXAMPLES

The present invention will now be described in more detail referring to the following example, but the present invention is not limited to the example.

### Example 1

The inorganic carbonic acid concentrations of water at the inlet and at the outlet of a demineralizer vessel of a condensate water demineralization vessel used in a certain nuclear power plant were measured using an electrical conductivity sensor with a gas permeation membrane. The MTC values with respect to the inorganic carbonic acid for a new anion exchange resin (the resin in a working demineralizer vessel immediately after the demineralization operation is started with a new anion exchange resin filled, by resin replacement), the some kind of resin \mathring{1} used on a working demineralizer vessel for about six months and regenerated, and the some kind of resin \mathring{2} used in a working demineralizer vessel for about two years and five months and regenerated were measured, and the ratios of these MTC valves to that of the new resin were determined. Some of the measuring conditions were as follows. The results are shown in Table 3.

(1) Height of the ion exchange resin layer in the demineralizer vessel: 1.2 m.

(2) Ratio between regenerated cation exchange resin and regenerated anion exchange resin: 2/1.

(3) Flow rate of passing water to the demineralizer vessel LV: 110 m/hr.

(4) Water temperature: 40° C.

(5) Concentration of various ion constituents at the inlet: NH₄⁺, 540 μg/L, N₂H₅⁺, 250 μg/L

For comparison purpose, the same anion exchange resins as above were sampled, mixed with a new cation exchange resin, and filled in a test column. The MTC values with respect to the sulfate ion and their ratios with respect to that of the new resin were then determined by the method of the prior art. Some of the measurement conditions were as follows. The results are shown in Table 3.

(1) Height of the ion exchange resin layer in the test column: 40 cm.

(2) Ratio between the new cation exchange resin and regenerated anion exchange resin: 2/1.

(3) Flow rate of passing water to the test column, LV: 110 m/hr.

(4) Sulfate ion concentration in the inlet water: 300 μg/L.

TABLE 3

| | new | resin \mathring{1} used in | resin \mathring{2} used in |
|---|---|---|---|
| | resin | demineralizer | demineralizer |
| inorganic carbonic acid | | | |
| concentration of inlet | 7.5 | 7.4 | 7.1 |
| water (μg/L) | | | |
| concentration of | 0.006 | 0.011 | 0.200 |
| outlet water (μg/L) | | | |
| removal | 99.92 | 99.85 | 97.18 |
| percentage (%) | | | |
| MTC × 10⁻⁴ (m/sec) | 1.20 | 1.11 | 0.61 |
| ratio to MTC of new | 1.00 | 0.92 | 0.50 |
| resin | | | |
| sulfate ion | | | |
| MTC × 10⁻⁴ (m/sec) | 2.00 | 1.80 | 1.05 |
| percentage with | 1.00 | 0.90 | 0.53 |
| respect to a new resin | | | |

By checking, in advance, the correlation between the MTC values with respect to the inorganic carbonic acid and to the sulfate ion and the respective ratios to that of the new resin, such as shown in Table 3, the reaction rate (reactivity) of the regenerated anion exchange resin can be easily known using the inlet and outlet water of the working demineralizer vessel using the on-line type method according to the present invention, without using the off-line type prior art method. The replacement timing or the like can thus be easily predicted and/or judged. It may also be useful to create, in advance, a suitable calibration curve (such, for example, as a calibration curve for the MTC values with respect to the sulfate ion and to the inorganic carbonic acid and/or for their ratios to that of the new resin). As can be seen from the removal percentage of the inorganic carbonic acid shown in Table 3, the removal percentage decreases as the performance of the anion exchange resin is degraded. Therefore, it is possible to judge the degree of degradation and the replacement timing of the anion exchange resin using the removal percentage of the inorganic carbonic acid in place of the MTC value as described above.

According to the embodiment, because the inorganic carbonic acid concentration of the water at the outlet, and if necessary, the inorganic carbonic acid concentration of the water at the inlet, of the ion exchange resin column such as a demineralizer vessel in a condensate water demineralization system can be directly measured for performance evaluation of the anion exchange resin for actual operation condition is possible, and furthermore, there is no need for sampling the ion exchange resin from the ion exchange resin vessel such as a demineralizer vessel during regeneration. Because there is a correlation between the MTC value with respect to the sulfate ion determined by the prior art method and the MTC value with respect to the inorganic carbonic acid determined according to the present invention, the MTC with respect to the inorganic carbonic acid can be calculated to very easily and simply judge the replacement timing, lifetime, and the throughput capacity of water for the anion exchange resin, using the correlation according to the specific needs. By continuously or intermittently monitoring the inorganic carbonic acid concentration on-line, the measurement precision can be improved, and in such a case, the data amount is also increased, and thus, it is possible to evaluate the performance of the anion exchange resin as time passes with high reliability.

According to the embodiment, the reactivity of the anion exchange resin can be measured without complicated steps such as sampling of the ion exchange resin from the ion exchange resin vessel such as a demineralizer vessel, pre-processing, test manipulation, and analysis manipulation, which are required in the prior art. The reactivity measurement test can thus be simplified. Moreover, unlike the prior art, variation due to the difference in skill of the analyzing personnel can be eliminated.

What is claimed is:

1. A method for evaluating the performance of an anion exchange resin, comprising the steps of:
measuring the inorganic carbonic acid concentration in the outlet water of an ion exchange resin vessel filled with at least an anion exchange resin; and
evaluating the performance of the anion exchange resin filled in said ion exchange resin vessel based on the obtained measurement value of the inorganic carbonic acid concentration in the outlet water.

2. A method according to claim 1, further comprising the steps of:
measuring the inorganic carbonic acid concentration in the inlet water of said ion exchange resin vessel; and
evaluating the performance of said anion exchange resin based on the inorganic carbonic acid concentrations of said outlet water and of said inlet water.

3. A method according to claim 1, wherein said inorganic carbonic acid concentration is continuously measured.

4. A method according to claim 1, wherein said inorganic carbonic acid concentration is intermittently measured.

5. A method according to claim 2, further comprising the steps of:
calculating an MTC (Mass Transfer Coefficient) of said anion exchange resin with respect to the inorganic carbonic acid from the measured values for the inorganic carbonic acid concentrations of the inlet water and of the outlet water of said ion exchange resin vessel; and
evaluating the performance of said anion exchange resin based on the obtained MTC.

6. A method according to claim 5, further comprising the steps of:
evaluating the degree of degradation of said anion exchange resin from said MTC; and
judging at least one of the replacement timing, lifetime, and throughput capacity for said anion exchange resin.

7. A method for evaluating the performance of an anion exchange resin filled in an ion exchange resin vessel, said method comprising the steps of:
providing a mini-column filled with at least the same anion exchange resin as the anion exchange resin in said ion exchange resin vessel, said anion exchange resin layer in said mini-column having a lower height than the height of said anion exchange resin layer filling said ion exchange resin vessel;
measuring the inorganic carbonic acid concentration of the outlet water of said mini-column by passing, from the inlet of said mini-column, a portion of the inlet water for said ion exchange resin vessel; and
evaluating the performance of the anion exchange resin filling said ion exchange resin vessel based on the obtained measurement value of the inorganic carbonic acid concentration in the outlet water of said mini-column.

8. A method according to claim 7, further comprising the steps of:
measuring the inorganic carbonic acid concentration of the outlet water of said ion exchange resin vessel; and
evaluating the performance of the anion exchange resin in said ion exchange resin vessel based on both said measurement results and the inorganic carbonic acid concentration of the outlet water of said mini-column.

9. A method according to claim 7, wherein the height of the layer of anion exchange resin filling said mini-column is equal to or lower than ½ of the height of the layer of the anion exchange resin filling said ion exchange resin vessel.

10. A method for evaluating the performance of an anion exchange resin filled in an ion exchange resin vessel, said method comprising the steps of:
providing a mini-column filled with at least the same anion exchange resin as the anion exchange resin in said ion exchange resin vessel, said anion exchange resin layer in said mini-column having a lower height than the height of said anion exchange resin layer filling said ion exchange resin vessel;
measuring inorganic carbonic acid concentrations of the inlet water and of the outlet water of said mini-column by passing, from the inlet of said mini-column, a portion of the inlet water for said ion exchange resin vessel; and
evaluating the performance of the anion exchange resin filling said ion exchange resin vessel based on the obtained measurement values of the inorganic carbonic acid concentrations of the inlet water and of the outlet water of said mini-column.

11. A method according to claim 10, further comprising the steps of:
measuring inorganic carbonic acid concentrations of the inlet water and of the outlet water of said ion exchange resin vessel; and
evaluating the performance of the anion exchange resin in said ion exchange resin vessel based on both the said measurement results and the inorganic carbonic acid concentrations of the inlet water and of the outlet water of said mini-column.

12. A method according to claim 10, wherein the height of the layer of anion exchange resin filling said mini-column is equal to or lower than ½ of the height of the layer of the anion exchange resin filling said ion exchange resin vessel.

13. A method according to claim 1, wherein said ion exchange resin vessel is a condensate water demineralizer vessel in a condensate water demineralization system.

14. A performance evaluation apparatus for anion exchange resins, comprising:
an outlet monitoring device for measuring the inorganic carbonic acid concentration of the outlet water of an ion exchange resin vessel filled with an anion exchange resin; and
an evaluation device for evaluating the performance of the anion exchange resin filling said ion exchange resin vessel based on the measurement value of the inorganic carbonic acid concentration of the outlet water obtained from said monitoring device.

15. An apparatus according to claim 14, further comprising:
an inlet monitoring device for measuring inorganic carbonic acid concentration of the inlet water of said ion exchange resin vessel; wherein
said evaluation device evaluates the performance of said anion exchange resin based on the inorganic carbonic acid concentrations of said outlet water and of said inlet water.

16. An apparatus according to claim 14, wherein said outlet monitoring apparatus continuously measures the inorganic carbonic acid concentration of said outlet water.

17. An apparatus according to claim 14, wherein said outlet monitoring apparatus intermittently measures the inorganic carbonic acid concentration of said outlet water.

18. An apparatus according to claim 15, wherein said evaluation apparatus calculates MTC (Mass Transfer Coefficient) of said anion exchange resin with respect to the inorganic carbonic acid from the measurement values of the inorganic carbonic acid concentrations of the inlet water and of the outlet water of said ion exchange resin vessel, and evaluates the performance of the anion exchange resin based on the obtained MTC.

19. An apparatus according to claim 18 wherein said evaluation apparatus evaluates the degree of degradation of the anion exchange resin from said MTC and judges at least one of replacement timing, lifetime, and throughput capacity for said anion exchange resin.

20. An apparatus according to claim 14 wherein said ion exchange resin vessel is a condensate water demineralization vessel of a condensate water demineralization system.

21. An apparatus for evaluating the performance of an anion exchange resin filling an ion exchange resin vessel, comprising:
a mini-column filled with the same anion exchange resin as the anion exchange resin of said ion exchange resin vessel and having the height of the layer of the anion exchange resin lower than the height of the layer of the anion exchange resin filling said ion exchange resin vessel;
a monitoring device for passing a portion of the inlet water of said ion exchange resin vessel from the inlet of said mini-column and measuring inorganic carbonic acid concentration of the outlet water of said mini-column; and
an evaluation device for evaluating the performance of the anion exchange resin filling said ion exchange resin vessel based on the obtained measurement value of the inorganic carbonic acid concentration of the outlet water of said mini-column.

22. An apparatus for evaluating the performance of an anion exchange resin filling an ion exchange resin column, comprising:
a mini-column filled with the same anion exchange resin as the anion exchange resin of said ion exchange resin vessel and having the height of the layer of the anion exchange resin lower than the height of the layer of the anion exchange resin filling said ion exchange resin vessel;
a monitoring device for passing a portion of the inlet water of said ion exchange resin vessel from the inlet of said mini-column and measuring inorganic carbonic acid concentrations of the inlet water and of the outlet water of said mini-column; and
an evaluation device for evaluating the performance of the anion exchange resin filling said ion exchange resin vessel based on the obtained measurement values of the inorganic carbonic acid concentrations of the inlet water and of the outlet water of said mini-column.
